(19) United States
(12) Patent Application Publication
(10) Pub. No.: US 2022/0382296 A1
(43) Pub. Date: Dec. 1, 2022

(54) GNSS DRIVE CONTROL DEVICE, GNSS CONTROLLER, WORK MACHINE, AND GNSS DRIVE CONTROL METHOD

(71) Applicant: Komatsu Ltd., Tokyo (JP)

(72) Inventors: Akira TANISHIGE, Tokyo (JP); Junki IRIE, Tokyo (JP); Daiki ARIMATSU, Tokyo (JP); Koichi SHIMA, Tokyo (JP)

(21) Appl. No.: 17/770,413

(22) PCT Filed: Nov. 5, 2020
(86) PCT No.: PCT/JP2020/041287

§ 371 Date: Apr. 20, 2022

(30) Foreign Application Priority Data
Nov. 5, 2019 (JP) 2019-201038

(51) Int. Cl. G05D 1/02

(52) U.S. Cl. CPC G05D 1/0278; G05D 1/0217

(57) ABSTRACT

A GNSS drive control device includes: a power signal reception unit that is configured to receive a power-off signal for a GNSS controller, and a shutdown processing unit that is configured to perform shutdown processing of the GNSS controller after a predetermined time has elapsed from reception of the power-off signal.

### DETAILED DESCRIPTION OF THE INVENTION

### Technical Field

The present disclosure relates to a GNSS drive control device, a GNSS controller, a work machine, and a GNSS drive control method.

Priority is claimed on Japanese Patent Application No. 2019-201038, filed Nov. 5, 2019, the content of which is incorporated herein by reference.

### BACKGROUND ART

Patent Document 1 discloses an input control method of a touch panel monitor for a work machine capable of allowing display on a monitor screen and preventing an erroneous operation input on a touch panel.

### CITATION LIST

### Patent Document

Patent Document 1 Japanese Unexamined Patent Application, First Publication No. 2015-202841

### SUMMARY OF THE INVENTION

### Problems to be Solved by the Invention

A work machine equipped with a GNSS (Global Navigation Satellite System) controller capable of measuring a global position and an azimuth direction is known. Normally, the GNSS controller is powered on and activated together with key-on of the work machine, that is, activation of the engine, and is powered off together with key-off of the work machine, that is, stop of the engine.

Normally, the GNSS controller receives signals from multiple satellites to perform an initialization immediately after the activation. This initialization may take several minutes depending on the reception status of the satellite signals.

For example, when having a conversation with other workers around a site, an operator of the work machine temporarily keys off the work machine. In such a case, not only is the work machine but also the GNSS controller powered off in response to the key-off operation. Then, even when the key-on operation is performed immediately after the conversation has finished, the activation of the GNSS controller and initialization of the GNSS controller are executed, and thus it takes time until appropriate position information after the initialization can be received.

In order to solve the above-described problem, it is conceivable to perform the power-off operation independently for the GNSS controller regardless of the key-off operation of the work machine. However, in such a case, when an operator who has finished the work for the day forgets to turn off the power of the GNSS controller after stopping the engine of the work machine, there is a problem in that the power-on state of the GNSS controller is maintained on and the battery of the work machine is consumed.

In view of the above-described problem, the present disclosure provides a GNSS drive control device, a work machine, and a GNSS drive control method capable of immediately receiving position information after initialization in a case where the work machine is temporarily keyed off and then keyed on again.

### Means for Solving the Problems

According to an aspect of the present disclosure, a GNSS drive control device includes: a power signal reception unit that is configured to receive a power-off signal for a GNSS controller; and a shutdown processing unit that is configured to perform a shutdown process of the GNSS controller after a predetermined time has elapsed from reception of the power-off signal.

### Effects of the Invention

According to the above-described aspect, in a case where the work machine is temporarily keyed off and then keyed on again, it is possible to immediately receive the position information after the initialization.

### BRIEF DESCRIPTION OF THE DRAWINGS

FIG. 1 is a diagram showing an overall configuration of a work machine according to a first embodiment.

FIG. 2 is a diagram showing a configuration of a cab of the work machine according to the first embodiment.

FIG. 3 is a diagram explaining a flow of a signal related to a power source according to the first embodiment.

FIG. 4 is a diagram explaining a flow of a signal related to the power source according to the first embodiment, and is a diagram explaining a partial configuration shown in FIG. 3 in more detail.

FIG. 5 is a diagram showing a functional configuration of a GNSS drive control device according to the first embodiment.

FIG. 6 is a diagram showing a process flow of the GNSS drive control device according to the first embodiment.

FIG. 7 is a diagram explaining a flow of a signal related to a power source according to the first modification of the first embodiment.

FIG. 8 is a diagram explaining a flow of a signal related to a power source according to the second modification of the first embodiment.

### DETAILED DESCRIPTION OF THE OUT THE INVENTION

### First Embodiment

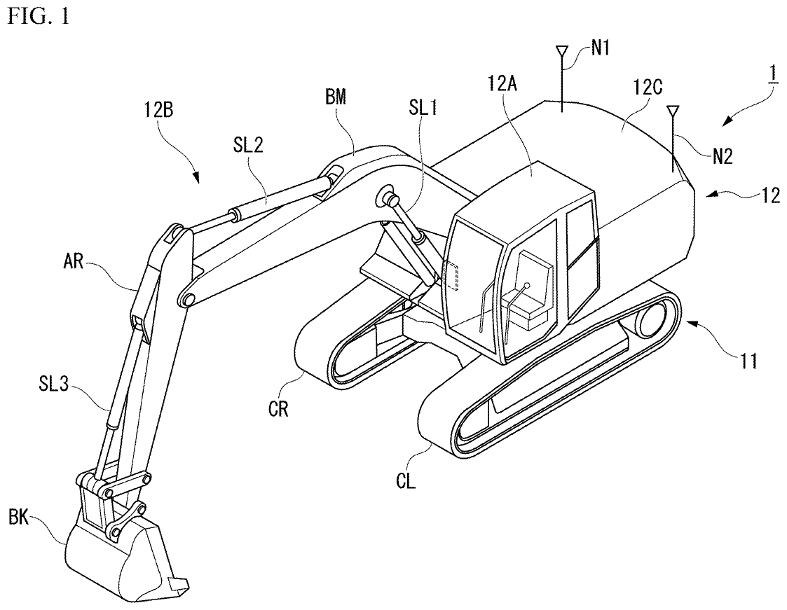

Hereinafter, a GNSS drive control device and a work machine including the same according to a first embodiment will be described in detail with reference to FIGS. 1 to 6.

(Structure of Work Machine)

FIG. 1 is a diagram showing a structure of the work machine according to the first embodiment.

A work machine 1, which is a hydraulic excavator, excavates and levels earth and the like at a work site or the like.

As shown in FIG. 1, the work machine 1, which is a hydraulic excavator, includes an undercarriage 11 for traveling and an upper swing body 12 provided on an upper portion of the undercarriage 11 and being capable of swinging around an axis being in a vertical direction. In addition, the upper swing body 12 is provided with a cab 12A, work equipment 12B, and two GNSS antennas N1 and N2.

The undercarriage 11 includes a left crawler track CL and a right crawler track CR. The work machine 1 moves forward, turns, and moves backward by rotation of the left crawler track CL and the right crawler track CR.

The cab 12A is a place where an operator of the work machine 1 gets on board to perform operation and driving. The cab 12A is provided, for example, on a left side portion of a front-end portion of the upper swing body 12.

The work equipment 12B includes a boom BM, an arm AR, and a bucket BK. The boom BM is attached to a front-end portion of the upper swing body 12. In addition, an arm AR is attached to the boom BM. In addition, a bucket BK is attached to the arm AR. A boom cylinder SL1 is attached between the upper swing body 12 and the boom BM. The boom BM can be operated with respect to the upper swing body 12 by driving the boom cylinder SL1. An arm cylinder SL2 is attached between the boom BM and the arm AR. The arm AR can be operated with respect to the boom BM by driving the arm cylinder SL2. A bucket cylinder SL3 is attached between the arm AR and the bucket BK. The bucket BK can be operated with respect to the arm AR by driving the bucket cylinder SL3.

The above-described upper swing body 12, boom BM, arm AR, and bucket BK included in the work machine 1, which is a hydraulic excavator, are one of aspects of a movable portion of the work machine 1.

Although the work machine 1 according to the present embodiment has been described as including the above-described configurations, in another embodiment, the work machine 1 does not necessarily include all of the above-described configurations.

(Configuration of Cab)

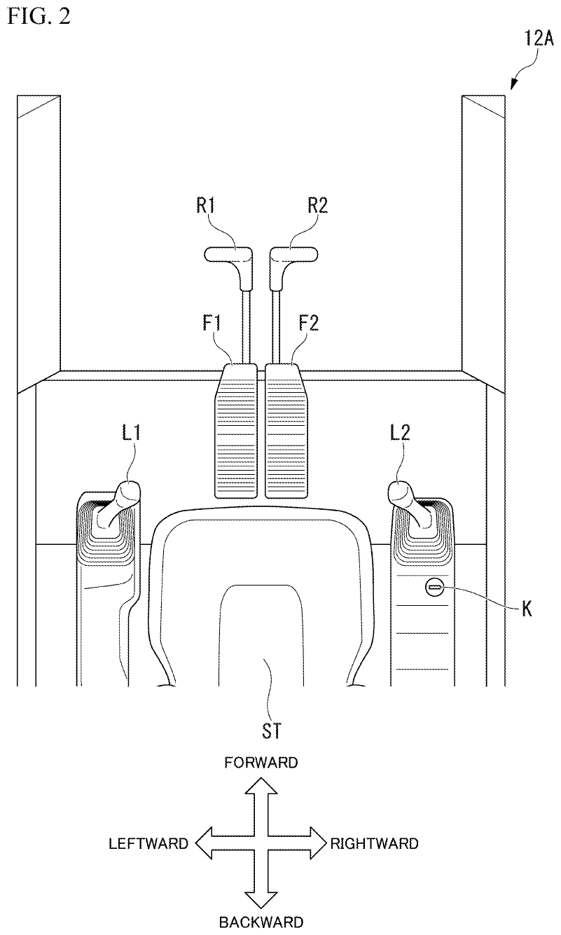

FIG. 2 is a diagram showing a configuration of the cab of the work machine according to the first embodiment.

As shown in FIG. 2, the cab 12A is provided with operating levers L1 and L2, foot pedals F1 and F2, and travel levers R1 and R2.

The operation lever L1 and the operation lever L2 are disposed on the left and right sides of a seat ST in the cab 12A. In addition, the foot pedal F1 and the foot pedal F2 are disposed on the floor surface in front of the seat ST in the cab 12A.

The operation lever L1 disposed on the left side when facing the front of the cab is an operation mechanism for performing a swing operation of the upper swing body 12 and an excavating and dumping operation of the arm AR. In addition, the operation lever L2 disposed on the right side when facing the front of the cab is an operation mechanism for performing an excavating and dumping operation of the bucket BK and a raising and lowering operation of the boom BM.

In addition, the travel levers R1 and R2 are operation mechanisms for performing an operation control of the undercarriage 11, that is, a traveling control of the work machine 1. The travel lever R1 disposed on the left side when facing the front of the cab corresponds to a rotational drive of the left crawler track CL of the undercarriage 11. The travel lever R2 disposed on the right side when facing the front of the cab corresponds to a rotational drive of the right crawler track CR of the undercarriage 11. In addition, the foot pedals F1 and F2 are respectively interlocked with the travel levers R1 and R2, and the traveling control can also be performed by the foot pedals F1 and F2.

A vehicle body key K is provided on the right side of the seat ST. The operator performs a key-on operation and a key-off operation using the vehicle body key K.

(Flow of Signals Related to Power Source)

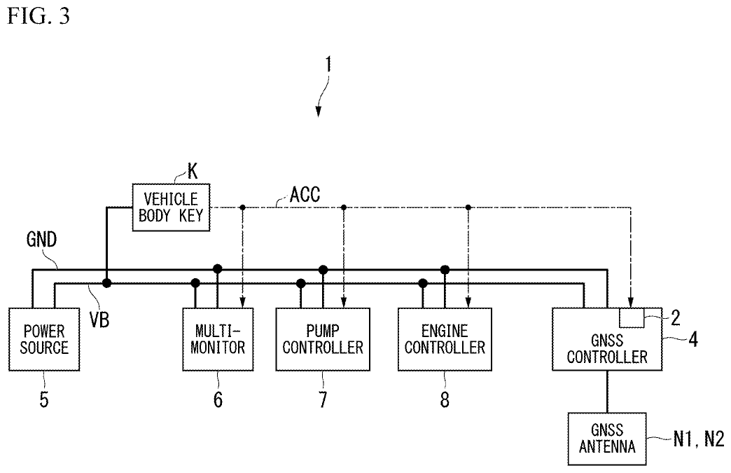

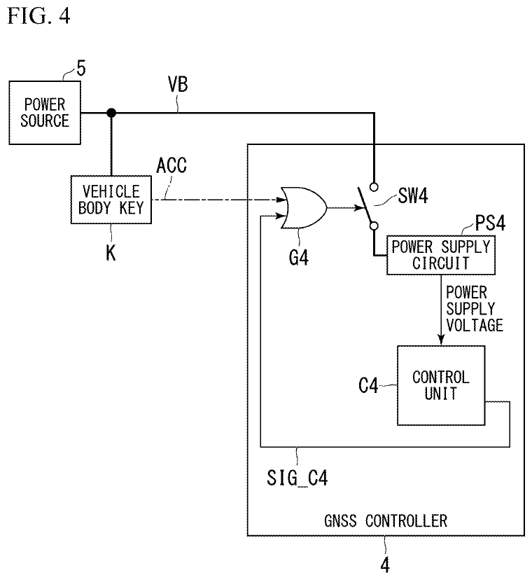

FIGS. 3 and 4 are diagrams explaining a flow of a signal related to the power source according to the first embodiment. FIG. 4 is a diagram explaining a part of the configuration shown in FIG. 3 in more detail.

As shown in FIG. 3, the work machine 1 includes a GNSS controller 4, a power source 5, a multi-monitor 6, a pump controller 7, and an engine controller 8. In addition, in the present embodiment, the GNSS drive control device 2 is built in the GNSS controller 4.

The GNSS controller 4 acquires each of absolute positions of the GNSS antennas N1 and N2 in the global coordinate system based on satellite signals received from the GNSS antennas N1 and N2. The GNSS controller 4 acquires position information indicating an absolute position of the work machine 1 in the global coordinate system based on the absolute positions of the two antennas N1 and N2. For example, the GNSS controller 4 calculates an intermediate position between the absolute positions of the two antennas N1 and N2 as the absolute position of the work machine 1.

In addition, the GNSS controller 4 calculates an azimuth direction of the work machine 1 in the global coordinate system based on the relative positional relationship between the two GNSS antennas N1 and N2. For example, the GNSS controller 4 calculates a straight line connecting the absolute positions of the two GNSS antennas N1 and N2 and calculates the azimuth direction of the work machine 1 based on an angle formed by the calculated straight line and a predetermined reference azimuth direction.

The GNSS controller 4 transmits the position information indicating the absolute position of the work machine 1 and azimuth direction information indicating the azimuth direction of the work machine 1 to a communication terminal (not shown). In addition to the position information and the azimuth direction information acquired by the GNSS controller 4, the communication terminal transmits information such as an operation time collected from the work machine 1 to the server. These pieces of information transmitted to the server are used for monitoring, management, and analysis of the work machine 1. In another embodiment, the GNSS controller 4 may have the function of the communication terminal.

In addition, the position information and the azimuth direction information calculated by the GNSS controller 4 may be transmitted to a vehicle body controller (not shown). In this case, the vehicle body controller performs intervention control based on the position information and the azimuth direction information. The intervention control is, for example, control by which a moving speed of the work equipment is reduced as a tip of bucket teeth approaches the target design surface. In addition, other control of the vehicle body may be performed. In addition, in another embodiment, control of the vehicle body of the work machine 1 may not be performed.

In addition, the GNSS controller 4 may transmit the position information or the azimuth direction information as a response to a request signal from another controller such as a communication terminal or a vehicle body controller. Further, regardless the response, the position information and the azimuth direction information may be transmitted to another controller, such as a communication terminal or a vehicle body controller, every time the position information indicating the absolute position of the work machine 1 and the azimuth direction information indicating the azimuth direction of the work machine 1 are acquired.

A predetermined operating voltage is supplied to the GNSS antennas N1 and N2 from the GNSS controller 4.

The GNSS drive control device 2 mounted in the GNSS controller 4 controls power-on and power-off of the GNSS controller 4. Specific operation of the GNSS Drive Control Device 2 will be described later.

In addition, the GNSS controller 4 includes hardware such as a CPU, a main storage device, an auxiliary storage device, and an input-output interface.

The multi-monitor 6 is a monitor that displays various instruments indicating states such as a fuel level and a coolant temperature.

The pump controller 7 controls an output of a hydraulic pump. The hydraulic pump is mechanically connected to the engine, is driven by driving of the engine, and discharges the hydraulic oil to hydraulic devices such as a boom cylinder SL1.

The engine controller 8 controls a fuel supply amount to the engine to control an output of the engine.

The power source 5 is a battery mounted as a constant power source of the work machine 1. The power source 5 supplies, for example, a direct-current (DC) power supply voltage of 24V to each controller described above through a power supply line VB and a ground line GND.

As shown in FIG. 3, when the vehicle body key K is key-on, a power-on signal ACC is transmitted from the vehicle body key K to each of the GNSS controller 4, the multi-monitor 6, the pump controller 7, and the engine controller 8. When the power-on signal ACC is received, each controller starts activation based on the DC power supply voltage supplied from the power source 5.

FIG. 4 shows part of an internal configuration of the GNSS controller 4. As shown in FIG. 4, the GNSS controller 4 includes a switch SW4, a power supply circuit PS4, a control unit C4, and an OR gate G4 thereinside.

The switch SW4 is a switch that is turned on and off in response to input of a power-on signal ACC and a power-off signal ACC. When the switch SW4 is turned on, the power supply circuit PS4 is connected to the power supply line VB, and the DC power supply voltage from the power source 5 is supplied to the power supply circuit PS4.

The power supply circuit PS4 converts the DC power supply voltage from the power source 5 into an appropriate power supply voltage, and inputs the converted power supply voltage to the control unit C4. Accordingly, the control unit C4 is activated.

The control unit C4 is, for example, a CPU or the like that performs a main process of the GNSS controller 4. The control unit C4 turns on a self-power-on signal SIG C4 during activation and inputs the signal to the OR gate G4. In this way, even when the power-off signal ACC is suddenly transmitted in response to a key-off operation by an operator, it is possible to prevent immediately cut off of the power supply to the control unit C4. The OR gate G4 having such a function is a so-called self-holding circuit and is used to secure time for transferring data in the memory to the non-volatile memory when the control unit C4 is powered off.

In addition, the OR gate G4 and the switch SW4 are implemented by discrete components such as transistors.

In addition, the multi-monitor 6, the pump controller 7, and the engine controller 8 have a power supply circuit, a self-holding circuit, and the like similar to those of the GNSS controller 4.

(Flow after Key-ON Operation)

A flow after the key-on operation will be described in detail with reference to FIGS. 3 and 4.

First, when the vehicle body key K is key-on by an operator in a state where the work machine 1 is stopped, the engine of the work machine 1 is operated. At the same time, the power-on signal ACC is simultaneously transmitted from the vehicle body key K to the GNSS controller 4, the multi-monitor 6, the pump controller 7, and the engine controller 8.

The power-on signal ACC input to the GNSS controller 4 is received by the OR gate G4 in the GNSS controller 4. Accordingly, the switch SW4 is turned on through the OR gate G4, and the control unit C4 of the GNSS controller 4 is activated based on the DC power supply voltage supplied from the power source 5.

When the GNSS controller 4 completes the activation, the GNSS controller 4 performs initialization. Thereafter, the GNSS controller 4 receives satellite signals from time to time, and transmits the position information and the azimuth direction information calculated based on the satellite signals to a communication terminal (not shown).

(Flow After Key-OFF Operation)

Next, a flow after the key-off operation will be described in detail.

When the vehicle body key K is key-OFF by the operator in a state in which the work machine 1 is activated, the engine of the work machine 1 is stopped. At the same time, a power-off signal ACC is transmitted from the vehicle body key K to the GNSS controller 4.

The power-off signal ACC input to the GNSS controller 4 is received by the control unit C4 in the GNSS controller 4. When the control unit C4 receives the power-off signal ACC from the vehicle body key K, the control unit C4 performs a shutdown process of the GNSS controller 4 after a predetermined time has elapsed from the time of receiving the power-off signal ACC. Details of this process will be described later.

(Functional Configuration of GNSS Drive Control Device)

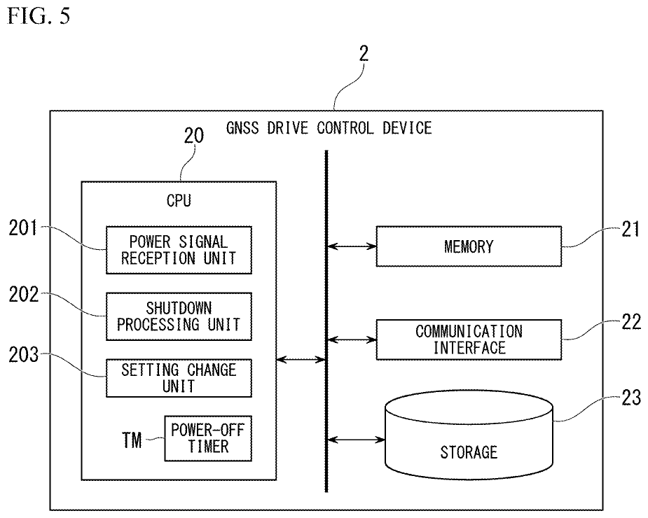

FIG. 5 is a diagram showing a functional configuration of the GNSS drive control device according to the first embodiment.

As shown in FIG. 5, the GNSS drive control device 2 includes a CPU 20, a memory 21, a communication interface 22, and a storage 23. In addition, the CPU 20 may be in any form such as an FPGA, a GPU, or the like as long as it is similar thereto.

In the present embodiment, the GNSS drive control device 2 may be configured by hardware separate from the hardware configuring the GNSS controller 4, or may be configured by common hardware. For example, the CPU 20, the memory 21, the communication interface 22, and the storage 23 may be configured by a CPU, a main storage device, an auxiliary storage device, an input-output interface, and the like configuring the GNSS controller 4. Any or all of the CPU 20, the memory 21, the communication interface 22, and the storage 23 may be configured by hardware separate from the CPUs, the main storage device, the auxiliary storage device, the input-output interface, and the like that configure the GNSS controller 4.

The CPU 20 is a processor that controls the entire operation of the GNSS drive control device 2. Various functions of the CPU 20 will be described later.

The memory 21 is a so-called main storage device. In the memory 21, commands and data necessary for the CPU 20 to operate based on a predetermined program are loaded.

The communication interface 22 is an input-output interface for transmitting and receiving a power-on signal and a power-off signal to and from the outside.

The storage 23 is a so-called auxiliary storage device, and is, for example, a hard disk drive (HDD), a solid-state drive (SSD), or the like.

Next, functions of the CPU 20 will be described in detail. The CPU 20 operates based on a predetermined program to exhibit functions as a power signal reception unit 201, a shutdown processing unit 202, and a setting change unit 203.

In addition, the predetermined program may be a program for realizing some functions to be exhibited by the GNSS drive control device 2. For example, the program may be a program for exhibiting the functions in combination with another program already stored in the storage 23 or another program installed in another device. In another embodiment, the GNSS drive control device 2 may include a custom LSI (Large-Scale Integrated Circuit) such as a PLD (Programmable Logic Device) in addition to or instead of the above configuration. Examples of the PLD include a PAL (Programmable Array Logic), a GAL (Generic Array Logic), a CPLD (Complex Programmable Logic Device), and an FPGA (Field Programmable Gate Array). In this case, some or all of the functions implemented by the processor may be implemented by the integrated circuit.

The power signal reception unit 201 receives the power-on signal ACC and the power-off signal ACC from the vehicle body key K.

The shutdown processing unit 202 performs a shutdown process of the GNSS controller 4 after a predetermined time has elapsed from the reception of the power-off signal ACC. For example, the shutdown processing unit 202 may turn off the power of the GNSS controller 4 by turning off the input of the OR gate G4 of the GNSS controller 4 after a predetermined time has elapsed from the reception of the power-off signal ACC received from the vehicle body key K. In addition, the power of the GNSS controller 4 may be turned off by turning off an output of the OR gate G4 or an output of the power supply circuit PS4 after a predetermined time has elapsed from the received time.

The setting change unit 203 changes the predetermined time based on an operation of the operator.

The CPU 20 has a built-in power-off timer TM having a timer function. The power-off timer TM may be in the form of software whose function is exhibited by the CPU 20 operating according to a program, or may be in the form of hardware configured by a logic circuit or the like. In another embodiment, the power-off timer TM may be installed outside the CPU 20.

(Process Flow of GNSS Drive Control Device)

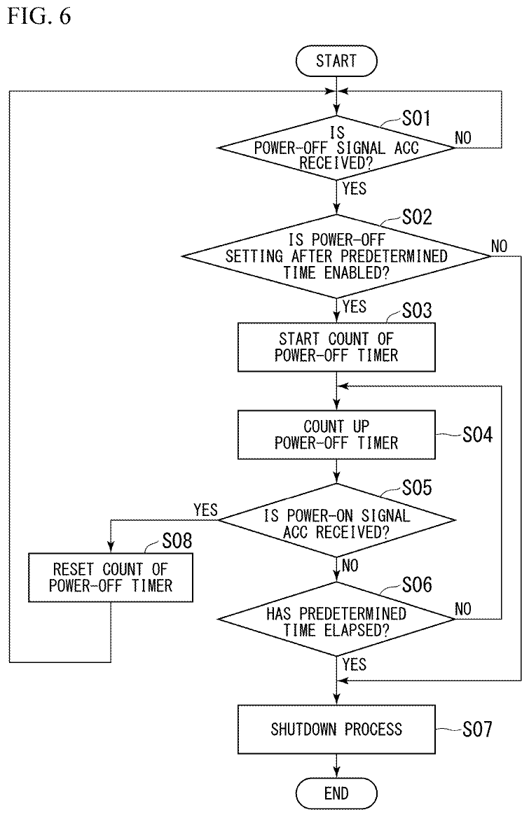

FIG. 6 is a diagram showing a process flow of the GNSS drive control device according to the first embodiment.

The process flow shown in FIG. 6 is started in a stage in which each controller of the work machine 1 is executing a normal process during activation.

The power signal reception unit 201 of the GNSS drive control device 2 determines whether or not the power-off signal ACC has been received from the vehicle body key K (step S01).

When the power-off signal ACC has not been received from the vehicle body key K (step S01; NO), the power signal reception unit 201 returns to the beginning of the process flow without performing any particular process.

When the power-off signal ACC is received from the vehicle body key K (step S01; YES), the shutdown processing unit 202 of the GNSS drive control device 2 determines whether or not a setting for turning off the power of the GNSS controller 4 after a predetermined time from the reception of the power-off signal ACC (hereinafter, also referred to as a power-off setting after a predetermined time) is enabled (step S02).

When the power-off setting after a predetermined time is disabled (step S02; NO), the shutdown processing unit 202 proceeds to the shutdown process in step S07 in order to immediately power off the GNSS controller 4.

When the power-off setting after a predetermined time is enabled (step S02; YES), the shutdown processing unit 202 starts counting the power-off timer TM in order to power off the GNSS controller 4 after a predetermined time (step S03).

The shutdown processing unit 202 counts up the power-off timer TM (step S04).

The power signal reception unit 201 determines whether or not the power-on signal ACC has been received from the vehicle body key K (step S05).

When the power-on signal ACC has not been received from the vehicle body key K (step S05; NO), the shutdown processing unit 202 determines whether or not the count of the power-off timer TM has reached the predetermined time (step S06).

When the count of the power-off timer TM has not reached the predetermined time (step S06; NO), the shutdown processing unit 202 returns to step S04 and continues the count-up of the power-off timer TM.

When the count of the power-off timer TM has reached the predetermined time (step S06; YES), the shutdown processing unit 202 executes shutdown processing in order to power off the GNSS controller 4 (step S07). Thus, the GNSS controller 4 is powered off.

On the other hand, when the power-on signal ACC is received from the vehicle body key K while the power-off timer TM is counting up (step S05; YES), the shutdown processing unit 202 resets the count of the power-off timer (step S08) and returns to the process of step S01. In other words, the shutdown process can be prohibited without executing the shutdown process. In this case, since the GNSS controller 4 maintains the power-on state until the operator performs the key-on operation again after performing the key-off operation, initialization does not need to be performed. Therefore, it is possible to immediately receive the position information or the like after the initialization from the GNSS controller 4.

In the above-described process flow, a mode of measuring the predetermined time by a method of counting up the power-off timer TM has been described; however, the present invention is not limited to this mode in another embodiment. In the above-described measurement of the predetermined time, a method of counting down the power-off timer TM may be used, or other well-known time measurement methods may be applied.

In addition, steps S03 to S04 and step S8 in each process flow described with reference to FIG. 6 are not essential components, and such steps may not be included in another embodiment.

(Function of Setting Change Unit)

The setting change unit 203 of the GNSS drive control device 2 can select the predetermined time from when the key-off operation is performed to when the power is turned off from three items, for example, “Immediately”, “1 hour later”, and “5 hours later”. In a case where an input of any one of “1 hour later” and “5 hours later” is received, the setting change unit 203 sets the predetermined time used for the determination of step S06 in FIG. 6 to one hour or five hours, respectively. In a case where an input of “Immediately” is received, the setting change unit 203 disables the power-off setting after a predetermined time. As a result, a determination of no is made in step S02 in FIG. 6, and after the key-off operation is received, the process proceeds to the shutdown process. In addition, when the predetermined time is set during the count-up of the power-off timer TM, the count time of the power-off timer TM may be updated to the set predetermined time.

The setting of the predetermined time may be selectable by a hardware switch provided on the housing of the GNSS controller 4, or may be selectable by software processing through the multi-monitor 6 or a terminal device such as another monitor or a tablet (not shown).

In addition, the process of changing the predetermined time by the setting change unit 203 may be automatically performed by software control or the like without being based on an operation of an operator.

In addition, the predetermined time from when the key-off operation is performed to when the GNSS controller 4 is actually powered off may be determined in a freely-selected manner regardless of the above-described set value. In addition, the predetermined time is preferably set such that the GNSS controller 4 maintains the power-on state to the end among all the components such as the multi-monitor 6 and the pump controller 7 connected to the signal related to the power source. In addition, the signal related to the power source is, for example, the power supply line VB, the power-on signal ACC, and the power-off signal ACC. In this way, the GNSS controller 4 can acquire the position information and the azimuth direction information of the work machine 1 from the key-off to the actual power-off. Further, the GNSS controller 4 may be set to maintain the power-on state, at least in preference to the engine controller 8 and the pump controller 7. In this way, it is possible to acquire the position information and the azimuth direction information of the work machine 1 until the GNSS controller 4 is actually powered off while stopping the output of the hydraulic pump and the output of the engine as soon as the key-off operation is performed.

(Operation and Effects)

As described above, the GNSS drive control device 2 according to the first embodiment includes the power signal reception unit 201 that is configured to receive the power-off signal for the GNSS controller 4, and the shutdown processing unit 202 that is configured to perform the shutdown process of the GNSS controller 4 after the predetermined time has elapsed since the reception of the power-off signal. According to such a configuration, in a case where the key-off of the work machine is temporarily performed and then the key-on is performed again within a predetermined time, the power of the GNSS controller 4 is maintained in the ON state. As a result, the GNSS controller 4 can provide the position information and the like without performing initialization.

### Other Embodiments

The GNSS drive control device according to the first embodiment has been described above in detail; however, specific aspects of the GNSS drive control device are not limited to those described above, and various design changes and the like can be added without departing from the gist.

(First Modification)

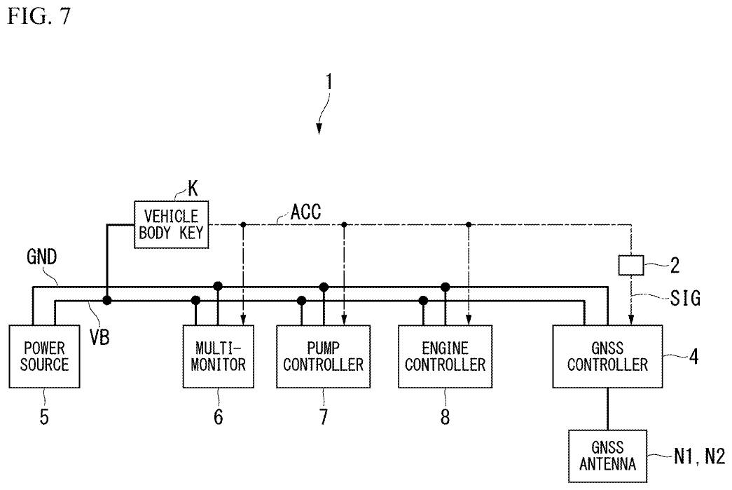

FIG. 7 is a diagram explaining a flow of a signal related to a power source according to a first modification of the first embodiment.

As shown in FIG. 7, a GNSS drive control device 2 according to the first modification is different from the GNSS drive control device 2 according to the first embodiment in that the GNSS drive control device 2 is provided separately from the GNSS controller 4.

The GNSS drive control device 2 according to the present modification directly receives the power-off signal ACC from the vehicle body key K. Then, the GNSS drive control device 2 transmits the power-off signal SIG to the GNSS controller 4 after a predetermined time has elapsed. The GNSS controller 4 is shut down in response to the reception of the power-off signal SIG. For example, the output of the OR gate G4 or the output of the power supply circuit PS4 is turned off in response to the reception of the power-off signal SIG. A process in which the GNSS drive control device 2 outputs the power-off signal SIG to the GNSS controller 4 is also included in the shutdown process.

As described above, the GNSS drive control device 2 may not belong to the GNSS controller or another controller, and may be installed independently of the GNSS controller or another controller.

(Second Modification)

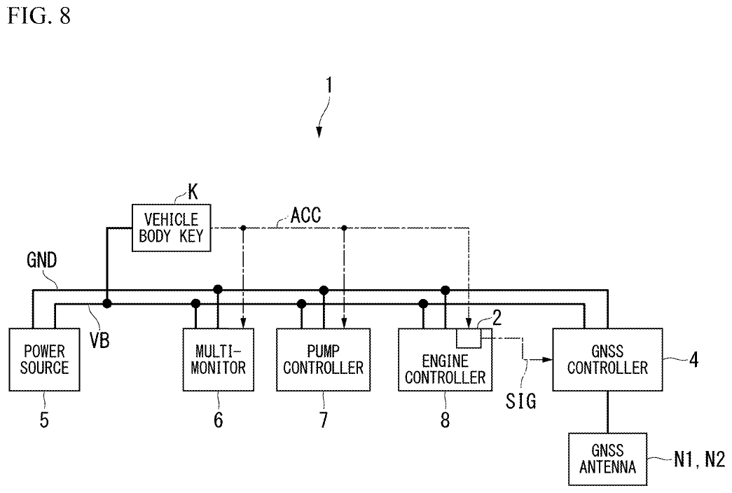

FIG. 8 is a diagram explaining a flow of a signal related to a power source according to a second modification of the first embodiment.

As shown in FIG. 8, a GNSS drive control device 2 according to the second modification is different from the first embodiment in that the GNSS drive control device 2 is provided inside an engine controller 8 that is another controller different from the GNSS controller 4.

The GNSS drive control device 2 according to the present modification receives a power-off signal ACC output from the vehicle body key K to the engine controller 8. Then, the GNSS drive control device 2 transmits the power-off signal SIG to the GNSS controller 4 after a predetermined time has elapsed. The GNSS controller 4 is shut down in response to the reception of the power-off signal SIG. For example, the output of the OR gate G4 or the output of the power supply circuit PS4 is turned off in response to the reception of the power-off signal SIG. A process in which the GNSS drive control device 2 outputs the power-off signal SIG to the GNSS controller 4 is also included in the shutdown process.

As described above, the GNSS drive control device 2 may be installed in another controller different from the GNSS controller. In addition, although the GNSS drive control device 2 is installed in the engine controller 8 as an example, it may be installed in another controller such as the multi-monitor 6 or the pump controller 7.

The above-described various processes of the GNSS drive control device 2 are stored in a computer-readable recording medium in the form of a program, and the various processes are performed by reading and executing the program by a computer. In addition, the computer-readable recording medium refers to a magnetic disk, a magneto-optical disk, a CD-ROM, a DVD-ROM, a semiconductor memory, or the like. In addition, the computer program may be distributed to a computer through a communication line, and the computer that has received the distribution may execute the program.

The program may be for realizing some of the above-described functions. Further, the program may be a so-called difference file, a difference program, or the like that can realize the above-mentioned functions in combination with a program already recorded in the computer system.

While some embodiments of the present disclosure have been described, these embodiments have been presented by way of example only, and are not intended to limit the scope of the disclosure. These embodiments can be implemented in various other forms, and various omissions, substitutions and changes can be made without departing from the scope of the disclosure. These embodiments and modifications thereof are included in the scope and gist of the disclosure, and are also included in the disclosure described in the claims and the equivalents thereof.

In the above-described embodiment, the work machine 1 has been described as a hydraulic excavator; however, in other embodiments, the present invention can be applied to various work machines such as a dump truck, a wheel loader, and a bulldozer.

In the embodiment described above, one GNSS drive control device 2 is installed in the work machine 1; however, another embodiment may realize a GNSS drive control system including two or more GNSS drive control devices with part of the configuration of the GNSS drive control device 2 being arranged in another GNSS drive control device. The GNSS drive control device 2 according to the above-described embodiment is also an example of the GNSS drive control system.

In addition, the GNSS drive control device 2 according to the above-described embodiment has been described as being installed in the work machine 1; however, in another embodiment, part or all of the configuration of the GNSS drive control device 2 may be installed outside the work machine 1.

In the above-described embodiment, the shutdown processing unit 202 turns off the output of the OR gate G4 or the output of the power supply circuit PS4 after the predetermined time has elapsed to power off the GNSS controller 4; however, in another embodiment, the GNSS controller 4 may be powered off by turning off the power source or an internal signal on the upstream side of the GNSS controller 4. For example, the GNSS controller 4 may be powered off by turning off the output of the power source 5 or the like.

In the above-described embodiment, the GNSS controller 4 is powered off in response to the transmission of the power-off signal SIG; however, in another embodiment, without transmitting the power-off signal SIG, the GNSS controller 4 may be powered off by turning off the power source or an internal signal on the upstream side of the GNSS controller 4. For example, the GNSS controller 4 may be powered off by turning off the output of the power source 5 or the like.

In the above-described embodiment, the GNSS controller 4 calculates the azimuth direction of the work machine 1; however, in another embodiment, the GNSS controller 4 may not calculate the azimuth direction.

### INDUSTRIAL APPLICABILITY

According to the above disclosure, in a case where the work machine is temporarily keyed off and then keyed on again, it is possible to immediately receive the position information after the initialization.

### DESCRIPTION OF REFERENCE NUMERALS

1: Work Machine
2: GNSS Drive Control Device
20: CPU
201: Power Signal Reception Unit
202: Shutdown Processing Unit
203: Setting Change Unit
21: Memory
22: Communication Interface
23: Storage
4: GNSS Controller
5: Power Source
6: Multi-monitor
7: Pump Controller
8: Engine Controller

1. A Global Navigation Satellite System (GNSS) drive control device, comprising:
a power signal reception unit that is configured to receive a power-off signal for a GNSS controller; and
a shutdown processing unit that is configured to perform a shutdown process of the GNSS controller after a predetermined time has elapsed from reception of the power-off signal.

2. The GNSS drive control device according to claim 1,
wherein the power signal reception unit receives a power-on signal for the GNSS controller, and
the shutdown processing unit prohibits a shutdown process of the GNSS controller in a case where the power-on signal is received before the predetermined time elapses.

3. The GNSS drive control device according to claim 1,
wherein the predetermined time is set to maintain a power-on state of the GNSS controller longer than the other controllers.

4. The GNSS drive control device according to claim 1, further comprising:
a setting change unit that is configured to change the predetermined time.

5. A GNSS controller comprising:
the GNSS drive control device according to claim 1.

6. A work machine comprising the GNSS drive control device according to claim 1.

7. A Global Navigation Satellite System (GNSS) drive control method, comprising:
receiving a power-off signal for the GNSS controller; and
transmitting the power-off signal to the GNSS controller after a predetermined time has elapsed from reception of the power-off signal.
